(19) United States
(12) Patent Application Publication
(10) Pub. No.: US 2020/0134657 A1
(43) Pub. Date: Apr. 30, 2020

(54) SYSTEM AND METHOD FOR FACILITATING PAYMENTS AND REWARD TRACKING

(71) Applicant: JPMORGAN CHASE BANK, N.A., New York, NY (US)

(72) Inventors: Ralph DARMO, West Chester, PA (US); Jeffrey E. MILLER, Media, PA (US); Howard SPECTOR, Woolwich, NJ (US); Allison BEER, Bronxville, NJ (US)

(21) Appl. No.: 16/664,138

(22) Filed: Oct. 25, 2019

Related U.S. Application Data
(60) Provisional application No. 62/751,092, filed on Oct. 26, 2018.

(51) Int. Cl. G06Q 30/02; G06Q 30/06

(52) U.S. Cl. CPC G06Q 30/0233; G06Q 30/0641; G06Q 30/0236

(57) ABSTRACT

Systems and methods for facilitating payments and reward tracking are disclosed. In one embodiment, in a merchant information processing apparatus comprising at least one computer processor, a method for facilitating customer payments and reward tracking may include: (1) providing an interface for accessing a financial institution backend in a merchant interface; (2) receiving user information from the financial institution backend; (3) generating a merchant loyalty account for the user based on the user information received from the financial institution backend; and (4) providing merchant loyalty account information to the financial institution backend.

### RELATED APPLICATIONS

This application claims the benefit of U.S. Provisional Patent Application Ser. No. 62/751,092, filed Oct. 26, 2018, the disclosure of which is hereby incorporated, by reference, in its entirety.

### BACKGROUND OF THE INVENTION

### 1. Field of the Invention

The present disclosure generally relates to systems and methods for facilitating payments and reward tracking.

### 2. Description of Related Art

It is commonplace for customers to purchase items online. Typically, the customer will select an item and go to a “checkout screen” where the customer then enters his or her credit card information, billing address, and shipping address. The merchant then provides this information to a financial institution to authorize the underlying transaction.

To create an account with the merchant, customers generally create a login (e.g., a username and password), and may enter information such as the customer's name, address, email address, credit card number, etc. The additional time and effort required for the user to create the merchant account often results in the account creation process being abandoned, with the customer deciding to checkout as a guest, or abandoning the transaction altogether.

### SUMMARY OF THE INVENTION

Systems and methods for facilitating payments and reward tracking are disclosed. In one embodiment, in a merchant information processing apparatus comprising at least one computer processor, a method for facilitating customer payments and reward tracking may include: (1) providing an interface for accessing a financial institution backend in a merchant interface; (2) receiving user information from the financial institution backend; (3) generating a merchant loyalty account for the user based on the user information received from the financial institution backend; and (4) providing merchant loyalty account information to the financial institution backend.

In one embodiment, the merchant interface may include a merchant website.

In one embodiment, the merchant interface may include a merchant computer application.

In one embodiment, the user information may include a name and contact information for the user.

In one embodiment, the method may further include collecting device fingerprint information and associating the device fingerprint information with the merchant loyalty account.

In one embodiment, the merchant may provide a merchant loyalty account balance or a merchant loyalty account activity to the financial institution backend.

According to another embodiment, in a financial institution information processing apparatus comprising at least one computer processor, a method for facilitating customer payments and reward tracking may include: (1) receiving, via a financial institution interface provided in a merchant interface, a request from a user to provide a merchant with user information; (2) providing the merchant with the user information; (3) receiving a merchant loyalty account identifier for the user; (4) receiving merchant loyalty account activity for the merchant loyalty account; (5) matching the merchant loyalty account activity with a transaction conducted with a financial instrument issued by the financial institution; and (6) communicating an offer to the user, wherein the offer is based on the matched merchant loyalty account activity and the transaction.

In one embodiment, the merchant interface may include a merchant website.

In one embodiment, the merchant interface may include a merchant computer application.

In one embodiment, the user information may include a name and contact information for the user.

In one embodiment, the method may further include collecting device fingerprint information and associating the device fingerprint information with the merchant loyalty account.

In one embodiment, the merchant loyalty account activity may include a merchant loyalty account balance or an addition or subtraction to the merchant loyalty account balance.

According to another embodiment, in an information processing apparatus for a consolidated reward program tracking provider, a method for consolidated reward tracking may include: (1) receiving, from a first loyalty program provider, a first account identifier for a first loyalty account with the first loyalty program provider for a user; (2) receiving, from a second loyalty program provider, a second account identifier for a second loyalty account with the second loyalty account provider for the user; (3) presenting, to the user, a loyalty points redemption opportunity with the first loyalty program provider or the second loyalty program provider; (4) receiving acceptance of the loyalty points redemption opportunity; (5) redeeming the loyalty points with the first loyalty program provider or the second loyalty program provider; and (6) redeeming the loyalty points with the first loyalty program provider or the second loyalty program provider.

In one embodiment, the consolidated reward program tracking provider may include one of the first loyalty program provider or the second loyalty program provider.

In one embodiment, the loyalty points redemption opportunity may be for the redemption of loyalty points with the first loyalty program provider with the second loyalty program provider.

In one embodiment, the loyalty points redemption opportunity may be for the redemption of loyalty points for a gift card with the first loyalty program provider or the second loyalty program provider.

In one embodiment, the consolidated reward program tracking provider may provide an online shopping portal for a plurality of merchants, and the loyalty points redemption opportunity is redeemed using the online shopping portal.

In one embodiment, the first account identifier or the second account identifier may include a messaging address, and the loyalty points redemption opportunity is communicated to the first account identifier or the second account identifier.

In one embodiment, the first account identifier or the second account identifier may include a messaging address, and the messaging address can only be used with one of the loyalty program providers.

### BRIEF DESCRIPTION OF THE DRAWINGS

In order to facilitate a fuller understanding of the present invention, reference is now made to the attached drawings in which:

FIG. 1 discloses a system for facilitating payments and reward tracking according to one embodiment;

FIG. 2 depicts a method for facilitating payments and reward tracking according to one embodiment;

FIG. 3 depicts a method for facilitating customer payments and reward tracking according to another embodiment;

FIG. 4 depicts a method for facilitating customer payments and reward tracking according to another embodiment;

FIG. 5 depicts a method for rewards tracking with a new rewards or loyalty account according to one embodiment;

FIG. 6 depicts a method for rewards tracking with an existing rewards or loyalty account according to one embodiment;

FIG. 7 depicts a method for consolidated reward tracking is provided according to one embodiment; and

FIG. 8 depicts a method for consolidated reward tracking according to one embodiment.

### DETAILED DESCRIPTION OF PREFERRED EMBODIMENTS

The following applications are hereby incorporated, by reference, in their entireties: U.S. patent application Ser. No. 14/744,608; U.S. patent application Ser. No. 14/699,511; U.S. Provisional Patent Application Ser. No. 62/148,493; U.S. Provisional Patent Application Ser. No. 62/107,800; and U.S. Provisional Patent Application Ser. No. 62/037,891.

Although embodiments may be described in the context of financial institutions, it should be recognized that this may include banks, credit card companies, financial technology (“FinTech”) service providers, and similar entities.

In embodiments, once a customer logs in to a payment application using a User ID, password, biometrics, etc., the customer's information that is already on file may be provided to the merchant. In addition, any rewards earned with the merchant may be automatically linked to the customer's account.

Thus, embodiments may reduce areas of friction for a customer in signing up for a merchant account.

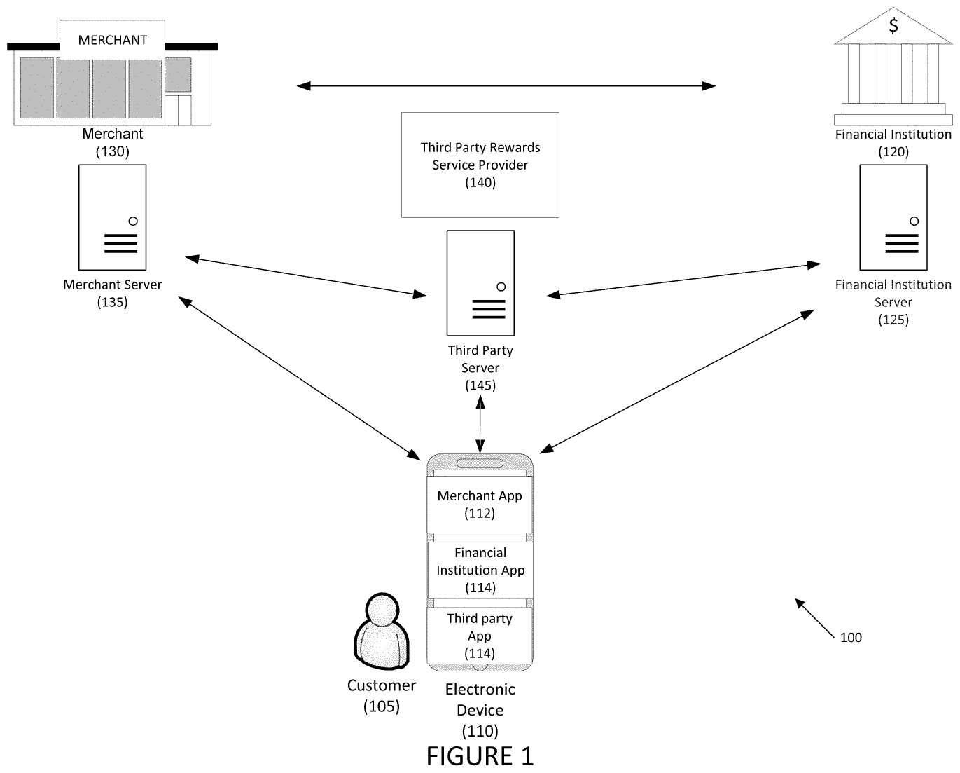

Referring to FIG. 1, a system for facilitating customer payments and reward tracking is disclosed according to one embodiment. System 100 may include electronic device 110 that may execute one or more computer programs or applications (“apps”), financial institution 120 may include one or more financial institution servers 125, and merchant 130 that may include one or more merchant servers 130.

Electronic device 110 may be any suitable electronic device that may be accessed or used by customer 105. For example, electronic device 110 may be a smartphone, smart watch, tablet computer, notebook computer, desktop computer, Internet of Things (IoT) appliances, etc.

Electronic device 110 may execute one or more computer programs or applications (“apps”), such as merchant app 112, financial app 114, and third party app 116. In one embodiment, the computer programs or apps may provide access to a website via a browser.

Financial institution 120 may be any suitable financial institution (e.g., a bank, a FinTech, etc.). Financial institution server 125 may be a physical server, a cloud-based server, combinations thereof, etc.

Merchant 130 may be any suitable provider of a good or service. Merchant 130 may include brick-and-mortar merchants, on-line merchants, etc. Merchant server 125 may be a physical server, a cloud-based server, combinations thereof, etc.

It should be recognized that although only one merchant 130 is depicted in FIG. 1, system 100 may include a plurality of merchants 130.

Merchant 130 and/or financial institution 120 may be providers of a loyalty or reward program. For example, merchant 130 and/or financial institution 120 may each have its own reward or loyalty program, or may participate in a reward or loyalty program for another merchant, financial institution, entity, etc.

Third party rewards service provider 140 may be a third party that provides services for one or more reward or loyalty programs. Third party rewards service provider 140 may provide or host third party server 145. Third party server 145 may communicate with financial institution server 125, merchant server 135, and/or merchant app 112, financial institution app 114, or third-party app 116.

In one embodiment, third party rewards service provider 140 may be another financial institution, another merchant, a Fintech, etc.

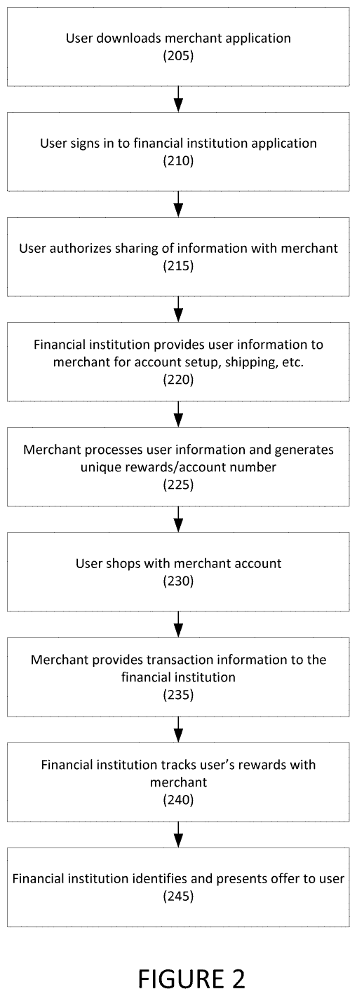

Referring to FIG. 2, a method for facilitating customer payments and reward tracking is disclosed according to one embodiment. In this embodiment, a user that is a customer of a financial institution may set up a new account with a merchant.

In step 205, a user may download and execute a merchant application on an electronic device. In another embodiment, the user may access a merchant website on a mobile device, a desktop computer, notebook computer, tablet computer, smart phone, Internet of Things (IoT) appliance, etc.

In step 210, in the merchant app or the merchant's website, the user may be prompted to sign into an account that the user may have with a financial institution. In one embodiment, the merchant may be a partner of the merchant, or have some other relationship. For example, the user may enter a username and password, authenticating information, etc.

In step 215, after the user is signed in, the user may authorize the financial institution to share user information with the merchant. In one embodiment, the user may provide an identifier for the merchant during the sign-on process.

In one embodiment, the user may select the type and/or amount of information that the financial institution shares with the merchant, such as the user's name, address, phone number, email address, etc.

In step 220, the financial institution may provide user information to the merchant for account setup, shipping, etc.

In step 225, the merchant may process the user information and may generate an account for the user. In one embodiment, the merchant may generate an account number or identifier, rewards number, etc.

In one embodiment, the merchant may collect and store device fingerprint information for the user's electronic device. For example, the merchant may collect and store a device identifier, serial number, etc. as is necessary and/or desired.

In one embodiment, the account number or identifier may be the user's phone number, email address, etc. Any other unique identifier may be used as is necessary and/or desired.

In step 230, the user may shop for goods or services on the merchant's application, website etc., and may conduct a transaction for the good or service.

In step 235, after the transaction is completed, the merchant may provide transaction information including reward or loyalty account information to the financial institution or the financial institution's application. This may include the user's loyalty or reward account identifier, a rewards or points balance, etc.

In one embodiment, the merchant may periodically provide reward or loyalty account updates to the financial institution when points are earned, redeemed, etc. In one embodiment, the merchant may periodically “heartbeat” reward or loyalty account updates to the financial institution.

In one embodiment, the merchant may provide additional details on rewards earned or redeemed, such as the basis for the rewards, what the reward was redeemed for, etc.

In step 240, the financial institution may track the user's rewards or points, and may present the reward or loyalty account information to the user. In one embodiment, the financial institution may periodically pull reward or loyalty account updates from the merchant.

In one embodiment, the financial institution may track the rewards for the merchant, or may track the rewards separately and in addition to the merchant. In one embodiment, if separate, the merchant's and the financial institution's reward tracking systems may be periodically synchronized.

In step 245, based on reward information, the financial institution may identify one or more offer or experience for the user. For example, based on the additional information received, the financial institution may use information on the basis for a reward-earning behavior to identify the offer or experience.

For example, for reward-earning behavior with an airline, the airline may provide the number of miles earned as well as trip details to the financial institution. The financial institution may then identify and provide an offer to the customer based on the trip, such as rewards to earn or use at the destination, in-flight reward earning or redemption opportunities, etc.

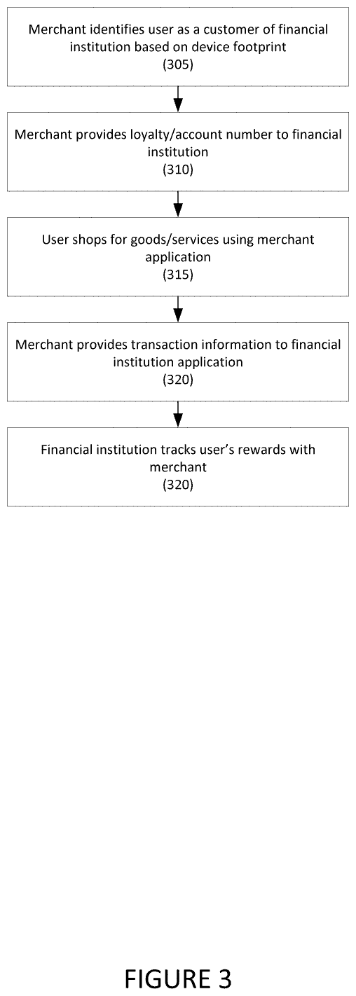

Referring to FIG. 3, a method for facilitating customer payments and reward tracking is disclosed according to another embodiment. In this embodiment, the user may be a customer of the financial institution and may also have an account with the merchant.

In step 305, a merchant (e.g., a merchant application) may identify a user as a customer of a financial institution partner based on, for example, a device footprint. For example, the merchant may identify the user based on a cookie stored in the electronic device, based on a device identifier, based on a browser footprint, based on the presence of a financial institution application on the electronic device, etc.

In one embodiment, the user may self-identify as a customer of the financial institution. In another embodiment, the merchant may identify the user as a customer of the financial institution based on payment information (e.g., the bank identification number of a credit card entered to pay for the transaction).

In step 310, the merchant application may provide the financial institution with the user's loyalty/rewards number, account number, etc. with the merchant. In one embodiment, the user's loyalty/rewards number may be a phone number, email address, or any other suitable identifier.

In one embodiment, the financial institution may require authentication before the user may access his or her account, pay for the transaction, etc.

In step 315, the user may shop the merchant's application, website etc. In one embodiment, the user may be given the option to pay with the financial institution's payment service.

In step 320, the after the transaction is completed, the merchant may provide transaction information, including reward information, to the financial institution's application, which, in step 325, may track the user's rewards with the merchant. In one embodiment, the financial institution may pull reward information from the merchant. In another embodiment, the merchant may push reward information to the financial institution.

In step 330, the financial institution may provide the merchant with updates to the merchant reward program. For example, based on transaction information, the financial institution may identify one or more offer for the user, such as a co-branded credit card, etc. This may be similar to step 245, above.

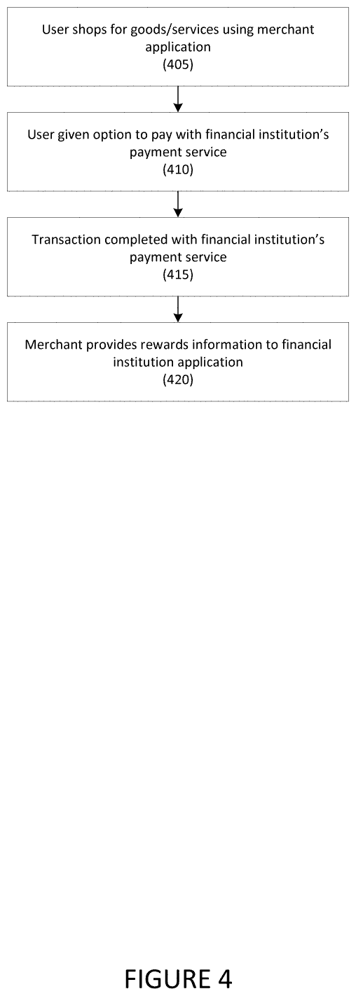

Referring to FIG. 4, a method for facilitating customer payments and reward tracking is disclosed according to another embodiment. In this embodiment, the user is not identified as a customer of the financial institution, but may be a customer of the merchant.

In step 405, the user may shop the merchant's application, website etc.

In step 410, the user may be given the option to pay with the financial institution's payment service. In one embodiment, this may be a static option that may be displayed for all customers. In another embodiment, the option may be provided if the merchant's application identifies the user as a customer of the financial institution based, for example, on a device fingerprint, a cookie stored on the electronic device, etc.

In one embodiment, the user may be identified as a customer of the financial institution following login to the financial institution's payment service.

In step 415, the transaction may be completed with the financial institution's payment service.

In step 420, after the transaction is completed, the merchant may provide reward information to the financial institution's application, which, in step 420, may track the user's rewards with the merchant.

In one embodiment, the financial institution may aggregate rewards for a plurality of merchants, and may periodically pull rewards information from the merchants. In another embodiment, the financial institution application may pull rewards information when requested. In another embodiment, the merchants may periodically push information to the financial institution.

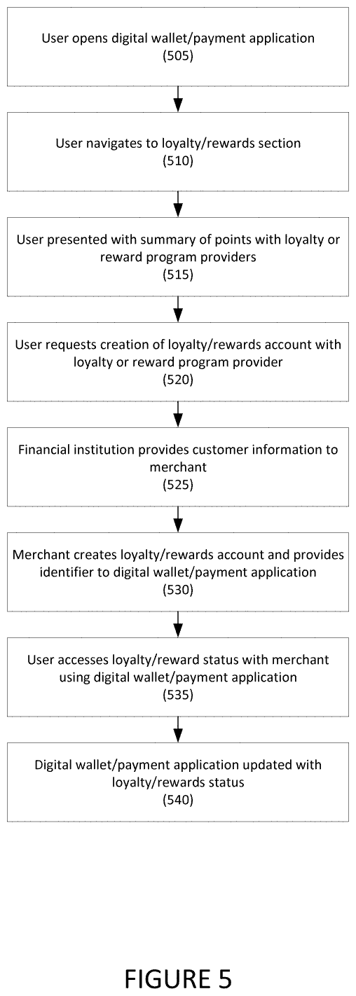

Referring to FIG. 5, a method for rewards tracking with a new rewards or loyalty account is disclosed according to one embodiment.

In step 505, a user may open a digital payment or digital wallet application provided by or for a financial institution.

In step 510, the user may navigate to a loyalty or rewards section of the application.

In step 515, the user may be presented with a summary of the user's reward points with one or more loyalty or reward points providers. In one embodiment, the user may be presented with loyalty or reward programs from partners of the financial institution with which the user may enroll.

In step 520, the user may request the creation of a loyalty or reward account with a loyalty or reward program provider via the digital payment application.

In step 525, the financial institution may send customer information that is required by the merchant to create the loyalty or rewards account to the merchant.

In step 530, the merchant may return a unique reward or loyalty account identifier to the digital payment application.

In step 535, the user may be presented with his or her loyalty/reward status within the digital payment application.

In step 540, the digital payment application may be updated with reward activity, points balance, etc. In one embodiment, the digital payment application may pull the information from the merchant. In another embodiment, the merchant may push the information to the digital payment application.

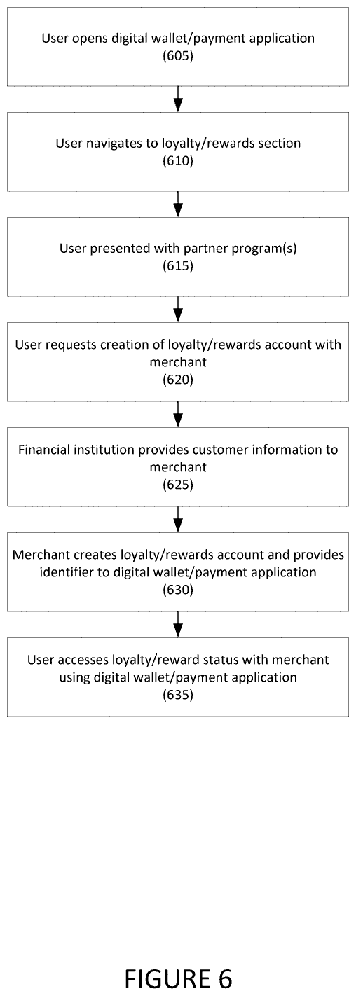

Referring to FIG. 6, a method for rewards tracking with an existing rewards or loyalty account is disclosed according to one embodiment.

In step 605, a user may open a digital payment or digital wallet application for a financial institution.

In step 610, the user may navigate to a loyalty or rewards section of the application.

In step 615, the user may be presented with a partner program that provides loyalty points, rewards, etc.

In step 620, the user may identify a partner with which the user has a loyalty or reward account, and may request linkage.

In step 625, the digital payment application and/or the financial institution backend may send customer information that is required by the merchant to link the financial institution account to the loyalty or rewards account. For example, the digital payment application and/or the financial institution backend may provide the customer name, address, phone number, etc. so that the merchant may search its records to identify the customer's loyalty or reward account. In another embodiment, the digital payment application and/or the financial institution backend may provide device fingerprint data. In another embodiment, the digital payment application and/or the financial institution backend may provide reward account information (e.g., reward account number), etc.

In step 630, the merchant may use the customer information to identify the user's reward or loyalty account information. For example, the merchant may use one or more of the name, email address, phone number, home address, device footprint, etc. to identify a matching or probable loyalty or reward account.

In one embodiment, if a confidence level is in the match is below a certain threshold (e.g., only 75 percent confidence), no match may be returned.

In step 635, if there is a match, or a confidence level above a certain threshold, the user may be presented with his or her loyalty/reward status within the digital payment application.

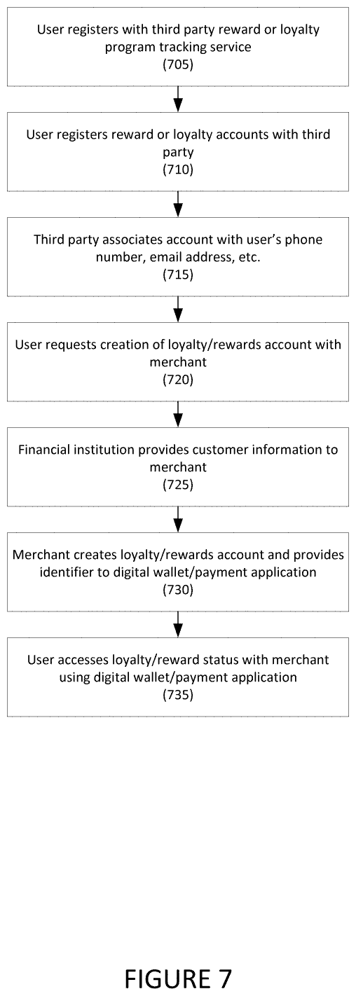

Referring to FIG. 7, a method for consolidated reward tracking is provided according to one embodiment.

In step 705, a user may register with a third-party reward or loyalty point tracking service. In one embodiment, the third party may be a financial institution, a merchant, a FinTech, etc. In one embodiment, the third party may be in communication with the merchants, financial institutions, etc. with which the user may have an account.

In one embodiment, the user may register an email address, phone number, user name, etc. with the third party as is necessary and/or desired.

In step 710, a user may register his or her loyalty or rewards accounts with a third party. In one embodiment, the user may provide loyalty or reward account identifiers for the accounts that the user is registering. In one embodiment the user may provide login credentials (e.g., username and password) for each loyalty or reward program that the user is registering.

In step 715, the third party may associate the phone number, email address, username, etc. with the rewards programs.

In step 715, the third party may contact each loyalty or reward program. In one embodiment, the third party may verify the login credentials are correct. In another embodiment, the third party may pull loyalty or reward points balances from each reward program.

In step 720, the third party may present the rewards points to the user.

In step 725, the third party may provide a rewards redemption opportunity to the user. In one embodiment, the third party may offer a redemption of loyalty or reward points for cash, may provide a shopping portal where the user may shop for merchandise, gift cards, etc., etc. using loyalty or reward points.

In step 730, the user may select an item to purchase with loyalty or reward points.

In step 735, the third party may contact the applicable loyalty or reward program provider to redeem the points.

In step 740, the loyalty or reward program provider may deduct the loyalty or reward points from the user's balance, and may communicate an updated balance to the third party.

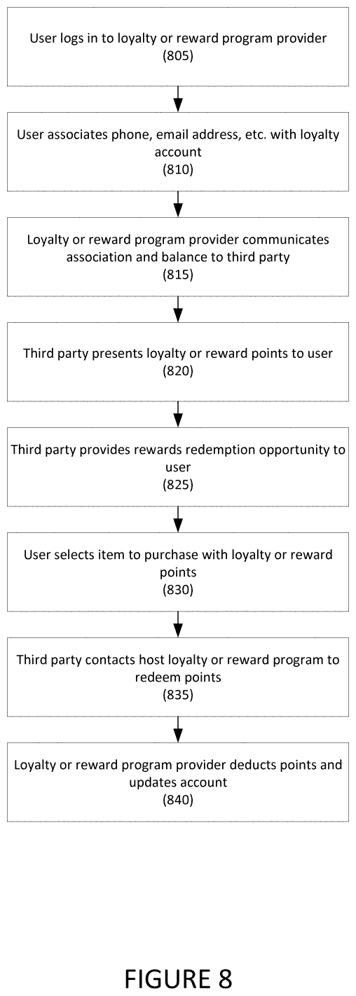

Referring to FIG. 8, a method for consolidated reward tracking is provided according to one embodiment.

In step 805, a user may login to a loyalty or reward program provider, such as a merchant or financial institution, with which the user participates in a loyalty or rewards program.

In step 810, the user may associate an email address, a phone number, or any other suitable identifier with the loyalty or rewards account. In one embodiment, each email address, phone number, etc. may only be associated with a single loyalty or rewards account.

In step 815, the loyalty or reward program provider may communicate the association of the loyalty or reward point account to a third-party reward or loyalty point tracking service (e.g., a financial institution, a merchant, a FinTech, etc.), and may further communicate an account balance to third party.

In step 820, the third party may present the rewards points to the user.

In step 825, the third party may provide a rewards redemption opportunity to the user. In one embodiment, the third party may offer a redemption of loyalty or reward points for cash, may provide a shopping portal where the user may shop for merchandise, gift cards, etc., etc. using loyalty or reward points.

In step 830, the user may select an item to purchase with loyalty or reward points.

In step 840, the third party may contact the applicable loyalty or reward program provider to redeem the points.

In step 845, the loyalty or reward program provider may deduct the loyalty or reward points from the user's balance, and may communicate an updated balance to the third party.

Although multiple embodiments have been disclosed, it should be recognized that these embodiments are not exclusive to one another, and aspects and features from one embodiment may be used with others.

Hereinafter, general aspects of implementation of the systems and methods of the invention will be described.

The system of the invention or portions of the system of the invention may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system. Thus, embodiments of the invention may include a processing machine running the iOS operating system, the OS X operating system, the Android operating system, the Microsoft Windows™ operating systems, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, the Apache operating system, an OpenStep™ operating system or another operating system or platform.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for facilitating customer payments and reward tracking, comprising:
in a merchant information processing apparatus comprising at least one computer processor:
providing an interface for accessing a financial institution backend in a merchant interface;
receiving user information from the financial institution backend;
generating a merchant loyalty account for the user based on the user information received from the financial institution backend; and
providing merchant loyalty account information to the financial institution backend.

2. The method of claim 1, wherein the merchant interface comprises a merchant website.

3. The method of claim 1, wherein the merchant interface comprises a merchant computer application.

4. The method of claim 1, wherein the user information comprises a name and contact information for the user.

5. The method of claim 1, further comprising:
collecting device fingerprint information and associating the device fingerprint information with the merchant loyalty account.

6. The method of claim 1, wherein the merchant provides a merchant loyalty account balance or a merchant loyalty account activity to the financial institution backend.

7. A method for facilitating customer payments and reward tracking, comprising:
in a financial institution information processing apparatus comprising at least one computer processor:
receiving, via a financial institution interface provided in a merchant interface, a request from a user to provide a merchant with user information;
providing the merchant with the user information;
receiving a merchant loyalty account identifier for the user;
receiving merchant loyalty account activity for the merchant loyalty account;
matching the merchant loyalty account activity with a transaction conducted with a financial instrument issued by the financial institution; and
communicating an offer to the user, wherein the offer is based on the matched merchant loyalty account activity and the transaction.

8. The method of claim 7, wherein the merchant interface comprises a merchant website.

9. The method of claim 7, wherein the merchant interface comprises a merchant computer application.

10. The method of claim 7, wherein the user information comprises a name and contact information for the user.

11. The method of claim 7, further comprising:
collecting device fingerprint information and associating the device fingerprint information with the merchant loyalty account.

12. The method of claim 7, wherein the merchant loyalty account activity comprises a merchant loyalty account balance or an addition or subtraction to the merchant loyalty account balance.

13. A method for consolidated reward tracking, comprising:
in an information processing apparatus for a consolidated reward program tracking provider, comprising:
receiving, from a first loyalty program provider, a first account identifier for a first loyalty account with the first loyalty program provider for a user;
receiving, from a second loyalty program provider, a second account identifier for a second loyalty account with the second loyalty account provider for the user;
presenting, to the user, a loyalty points redemption opportunity with the first loyalty program provider or the second loyalty program provider;
receiving acceptance of the loyalty points redemption opportunity;
redeeming the loyalty points with the first loyalty program provider or the second loyalty program provider; and
redeeming the loyalty points with the first loyalty program provider or the second loyalty program provider.

14. The method of claim 13, wherein the consolidated reward program tracking provider comprises one of the first loyalty program provider or the second loyalty program provider.

15. The method of claim 13, wherein the loyalty points redemption opportunity is for the redemption of loyalty points with the first loyalty program provider with the second loyalty program provider.

16. The method of claim 13, wherein the loyalty points redemption opportunity is for the redemption of loyalty points for a gift card with the first loyalty program provider or the second loyalty program provider.

17. The method of claim 13, wherein the consolidated reward program tracking provider provides an online shopping portal for a plurality of merchants, and the loyalty points redemption opportunity is redeemed using the online shopping portal.

18. The method of claim 13, wherein the first account identifier or the second account identifier comprises a messaging address, and the loyalty points redemption opportunity is communicated to the first account identifier or the second account identifier.

19. The method of claim 13, wherein the first account identifier or the second account identifier comprises a messaging address, and the messaging address can only be used with one of the loyalty program providers.
